(19) United States
(12) Patent Application Publication
(10) Pub. No.: US 2009/0188867 A1
(43) Pub. Date: Jul. 30, 2009

(54) METHODS AND SYSTEMS FOR PROCESSING WASTE WATER

(76) Inventors: Dinh-Cuong Vuong, Sugar Land, TX (US); David M. Polizzotti, Yardley, PA (US); James Scott Kain, Houston, TX (US); Robert Henry Weed, North Wales, PA (US)

Correspondence Address: JOHN S. BEULICK (17851);ARMSTRONG TEASDALE LLP, ONE METROPOLITAN SQUARE, SUITE 2600, ST. LOUIS, MO, 63102-2740, US

(21) Appl. No.: 12/022,707

(22) Filed: Jan. 30, 2008

(51) Int. Cl. B01D 61/02; B01D 61/08

(52) U.S. Cl. 210/652; 210/500.27

(57) ABSTRACT

A method for processing wastewater is provided. The method includes concentrating a flow of the wastewater using a reverse osmosis process membrane, and evaporating the concentrated flow to produce at least distillate and solids.

### BACKGROUND OF THE INVENTION

The field of the invention relates generally to industrial wastewater processing systems and, more particularly, to systems that process gasification process wastewater or grey water blowdown.

Industrial process water is typically classified as black water or grey water. Black water is process water that may include high levels of suspended solids and dissolved gases. To reuse the water, black water is converted to grey water for reuse by processes that reduce suspended solids, pressure, and temperature. Thus, grey water contains less suspended solids and dissolved gases as compared to black water. A portion of grey water is blown down for reducing contaminants that may adversely affect the industrial process. Such wastewater, or grey water blowdown, may be produced by industrial applications, such as gasification systems.

Black water and grey water are the terms commonly used to describe water streams in the gasification process. The characteristics of grey water from a gasification system depend on gasifier feedstock and/or gasification process operating conditions, and such grey water may include ammonia, chloride, and formate. Gasification grey water may also include other components, such as alkali and alkaline earth metals, carbon dioxide, suspended solids, transition metals and other reactive species such as silica and sulfides. Known gasification grey water has a pH range from approximately 5.5 to approximately 8 and may have a temperature of about 180° F. when discharged into a wastewater processing system. If the grey water is in the lower pH region, the grey water may be corrosive and, as such, may induce wear on components within the wastewater processing system.

At least one known wastewater processing system for use with grey water treats grey water blowdown, or wastewater, to remove unwanted contaminants before the water is discharged to a water outfall. Wastewater may be treated in an ammonia stripper column to remove ammonia. The stripped ammonia vapor may be disposed in a Sulfur Recovery Unit (SRU). Water discharged from the ammonia stripper is further treated to meet environmental requirements prior to being discharged. For example, a biological treating process may be used to remove formate from the wastewater. If the discharge water does not meet specifications, the wastewater is stored in holding tanks for further testing before final disposition.

Another known wastewater treatment system for gasification grey water blowdown, or wastewater, uses a full-flow zero liquid discharge (ZLD) process. A ZLD process is a process that does not produce a liquid waste discharge stream. Known wastewater ZLD processes include a falling-film evaporator, a forced circulation evaporator, and a drum dryer to produce a solid waste for disposal and to produce water for reuse in the gasification process. In at least some known ZLD processes, wastewater is pre-treated before it is channeled to the falling-film evaporator. More specifically, pre-treating the wastewater may include clarification and/or filtration treatments. However, process components in such known ZLD process systems require the use of materials that are resistant to corrosion. Further, such known ZLD processes may use additional steam for evaporating the wastewater because of scaling in the evaporating system. Steam from within the power plant could have otherwise been used to produce power. As such, known ZLD process systems may be costly in terms of both capital and operational expenses.

### BRIEF DESCRIPTION OF THE INVENTION

In one aspect, a method for processing wastewater is provided. The method includes concentrating a flow of the wastewater using a reverse osmosis process membrane, and evaporating the concentrated flow to produce at least distillate and solids.

In another aspect, a system for processing wastewater is provided. The wastewater processing system includes a separation system including a reverse osmosis membrane. The separation system is configured to reduce a flow volume of the wastewater. The wastewater processing system also includes an evaporation system for receiving the reduced flow of the wastewater from the separation system.

In yet another aspect, a separation system for processing wastewater is provided. The separation system includes a first membrane including a polymer film based filtration means and a second membrane including a reverse osmosis membrane material. The second membrane facilitates reducing a flow volume of the wastewater.

### BRIEF DESCRIPTION OF THE DRAWINGS

FIG. 1 is a schematic illustration of an exemplary gasification for syngas generation system.

FIG. 2 is a schematic illustration of an exemplary wastewater processing system that may be used with the gasification for syngas generation system shown in FIG. 1.

FIG. 3 is a schematic illustration of an alternative wastewater processing system that may be used with the gasification for syngas generation system shown in FIG. 1.

### DETAILED DESCRIPTION OF THE INVENTION

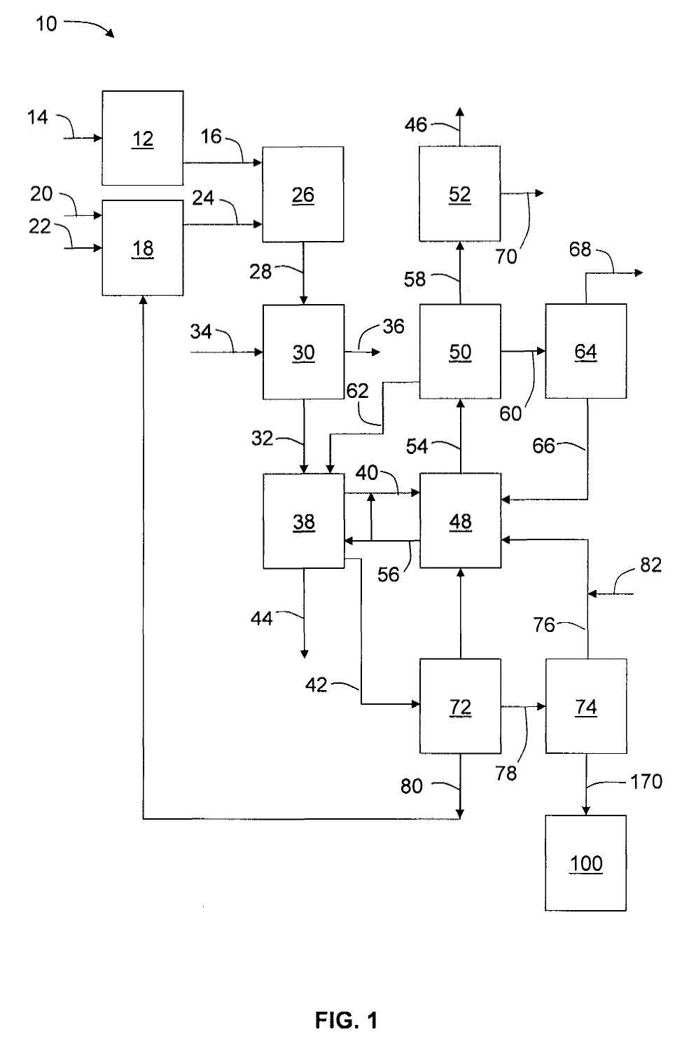

FIG. 1 is a schematic diagram of an exemplary gasification for syngas generation system 10. Syngas generation system 10 generally includes an air separation unit (ASU) 12 for separating air 14 to produce gasifier oxygen 16 and a carbonaceous fuel preparation unit 18 for preparing carbonaceous fuel 20 and water 22 to produce gasifier fuel 24. ASU 12 and fuel preparation unit 18 are coupled in flow communication to a gasifier 26 that produces a gas/solids mixture 28 by a partial oxidation process of gasifier oxygen 16 and fuel 24. The gas/solids mixture 28 includes the main product synthetic gas (“syngas”) and by-products, which may include solids, such as slag and unburned carbon. Gasifier 26 is coupled in flow communication to a syngas cooler 30 that cools the gas/solids mixture 28 to a cooled gas/solids mixture 32. Boiler feed water 34 is fed into syngas cooler 30 to produce steam 36 for using in downstream units. Syngas cooler 30 is coupled in flow communication to a gas/liquid/solids separation apparatus 38 where the cooled gas/solids mixture 32 is separated into raw syngas 40 (gas), black water 42 (liquid), and slag 44 (solids). Slag 44 is a by-product which may be reused and/or disposed of off-site.

Raw syngas 40 is converted to clean syngas 46 by processing raw syngas 40 serial through a syngas scrubber 48, a syngas cooling system 50, and an acid gas removal system 52. More specifically, syngas scrubber 48 scrubs particulates from raw syngas 40 to produce scrubbed syngas 54 and produces water 56 for use in gas/liquid/solids separation apparatus 38. Syngas cooling system 50 cools the scrubbed syngas 54 to produce low temperature syngas 58 to be channeled to acid gas removal unit 52 and to produce condensate 60 and 62 for processing within a condensate stripper 64 and gas/liquid/solids separation apparatus 38, respectively. Condensate stripper 64 strips ammonia from condensate 60 to produce stripped condensate 66 for use in syngas scrubber 48 and to produce a by-product ammonia gas 68 for processing and/or disposal in downstream units. Acid gas removal system 52 removes acid gas 70 from low temperature syngas 58 to produce clean syngas 46. Acid gas 70 is a by-product that may be processed and/or disposed of in downstream units. Clean syngas 46 is the main product of the syngas generation system 10 and can be used for power production, chemical productions, and/or other usage.

Black water 42 from gas/liquid/solids separation apparatus 38 is channeled to a black water handling unit 72. Black water handling unit 72 separates black water 42 into grey water 78 for processing in grey water handling unit 74 and a stream 80 having a high concentration of suspended solids, wherein the stream 80 can be reused in fuel preparation unit 18. Grey water handling unit 74 processes grey water 78 to produce a relative lower suspended solids grey water 76 for using in syngas scrubber 48 and a relatively higher suspended solids grey water 170 as wastewater. Grey water 76, which has less suspended solids as compared to black water 42 or grey water 78 and/or 170, may be combined with makeup water 82, if needed, and is used in syngas scrubber 48 as a scrubbing water for the raw syngas 40. A portion of grey water 78 is discharged as wastewater or grey water blowdown 170 to a wastewater processing system 100 for reducing contaminant buildup that may adversely affect syngas generation system 10.

System 100 is a wastewater processing system, which is in flow communication with at least one wastewater source, such as, for example, grey water handling system 74 of the syngas generation system 10. A chemical store 84 and a plant steam system 86 are in flow communication with wastewater processing system 100 for supplying chemicals and steam, respectively, to wastewater processing system 100, as described in more detail below.

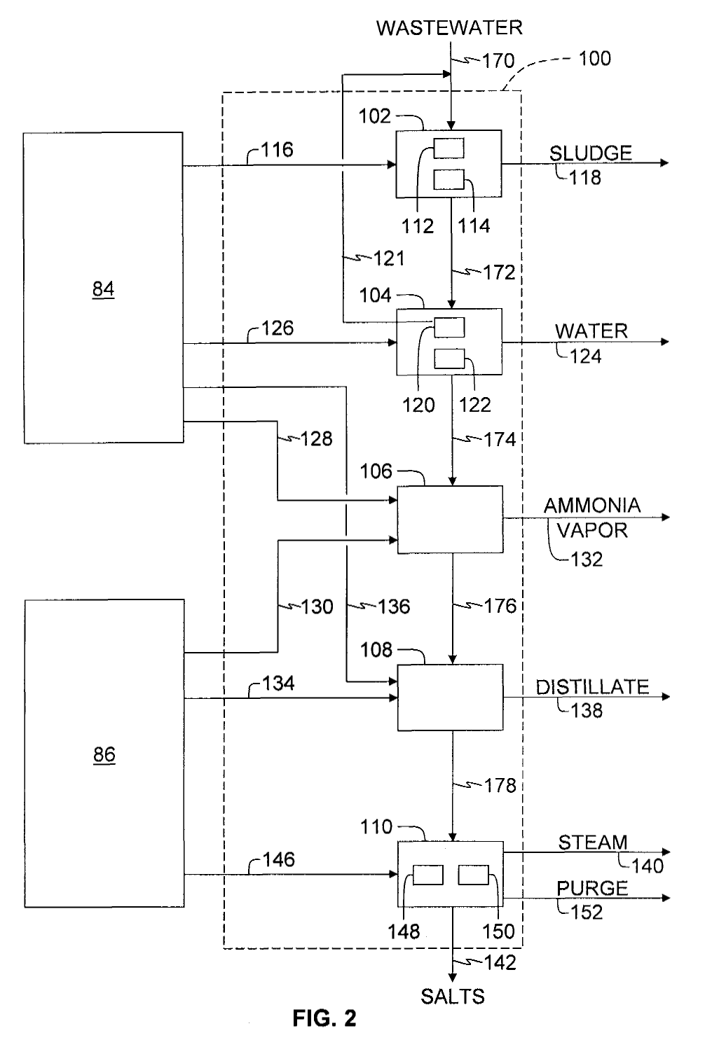

FIG. 2 is a schematic illustration of an exemplary wastewater processing system 100 that may be used with syngas generation system 10 (shown in FIG. 1). In the exemplary embodiment, wastewater processing system 100 includes a pretreatment system 102, a separation system 104, an ammonia stripping system 106, an evaporation system 108, and a drying system 110. Pretreatment system 102 receives wastewater 170 from, for example, syngas generation system 10 (shown in FIG. 1) and processes wastewater 170 such that, for example, wastewater 170 is softened and/or filtered. More specifically, pretreatment system 102 includes a softening system 112 and/or a filter system 114.

To soften wastewater 170, pretreatment system 102 receives chemicals 116 from chemical store 84 at softening system 112. Such chemicals 116 include, for example, but are not limited to including, calcium, lime, caustics, and/or magnesium compounds, to soften grey water 170 by reducing hardening substances and some metal values within wastewater 170. As used herein, the term “caustic” refers to a source of hydroxide ion. Further, as used herein, the term “hardening substances” refers to substances including dissolved minerals and/or ions, such as calcium, bicarbonate, sodium, chloride, and/or magnesium ions, therein. In the exemplary embodiment, lime and/or caustics are alkalizing agents, and magnesium compounds are used to reduce silica. By softening wastewater 170, hardening substances are faciltiated to be reduced. As such, the fouling potential of wastewater processed in system 100 is reduced in downstream operations because the water 170 includes less hardening substances that tend to adhere to and/or corrode surfaces within the processing system 100. For low scale-potential wastewater 170, softening process and/or softening system 112 may be omitted from pretreatment system 102.

Further, in the exemplary embodiment, pretreatment system 102 filters wastewater 170 at filter system 114 using, for example, a polymer, such as a coagulant and/or a flocculant, multimedia filter to remove suspended solids from wastewater 170. More specifically, in the exemplary embodiment, organic coagulants and/or organic flocculants, such as, but not limited to, diallyldimethylamine ammonium chloride (DADMAC) polymers, are supplied to pretreatment system 102 to facilitate removing solids from wastewater 170 by, for example, coagulating and/or flocculating solids within wastewater 170. Pretreatment system 102 then discharges pretreated wastewater 172 to separation system 104 and discharges sludge 118 to a disposal unit. As used herein, the term “sludge” refers to accumulated and/or concentrated solids generated within a treatment process that have not undergone a stabilization process. As such, in the exemplary embodiment, pretreatment system 102 facilitate removing from the wastewater at least one of a hardening substance, a scale-forming substance, a silica, a metal oxide, and an inorganic substance. Alternatively, pretreatment system 102 processes wastewater 170 by any suitable means that enables wastewater processing system 100 to function as described herein. In one embodiment, pretreatment system 102 is omitted from wastewater processing system 100.

In the exemplary embodiment, separation system 104 receives pretreated wastewater 172 and performs a concentration process on the water 172. More specifically, in the exemplary embodiment, separation system 104 includes a first membrane system 120 and a second membrane system 122. In one embodiment, separation system 104 includes a heat exchanger to facilitate maintaining operating temperatures and/or membrane integrity. Each membrane system 120 and 122 includes a number of membranes that is sufficient to process the volume of wastewater channeled through wastewater processing system 100. In the exemplary embodiment, first membrane system 120 includes a polymer film based filtration means, such as an ultrafiltration (UF) membrane that has been fabricated from a polyvinlyidinedifluoride material, a polysuflone material, a polyethersulfone material, and/or any other suitable UF polymer. Alternatively, first membrane system 120 includes a nanofiltration (NF) membrane, a microfiltration (MF) membrane, and/or any other suitable filtration membrane. In the exemplary embodiment, first membrane system 120 facilitates reducing and/or eliminating fouling of second membrane system 122 by conditioning pretreated wastewater 172 before the pretreated wastewater 172 enters second membrane system 122. To condition wastewater 172 prior to the wastewater entering first membrane system 120, chemicals 126 from chemical store 84 are added to pretreated wastewater 172. Chemicals 126 include, for example, but are not limited to acid, caustic, coagulant, flocculent, and chlorine. The foulants removed by first membrane system 120 constitute a relatively small flow 121, which is returned to pretreatment system 102 for additional treatment along with wastewater 170.

Second membrane system 122, in the exemplary embodiment, includes a reverse osmosis (RO) process membrane. An RO process is a separation process that uses pressure in excess of an osmotic pressure to force a solvent through a membrane. The membrane retains a solute on one side and allows the purified solvent to pass therethrough. As such, the solvent is forced from a region of high solute concentration, through the membrane within second membrane system 122, to a region of low solute concentration. In the exemplary embodiment, pretreated wastewater 172 includes solvent and solutes, the solvent is purified water 124, the solutes are dissolved and suspended solids, and concentrated wastewater 174 that is further processed within wastewater processing system 100 is solvent with concentrated solutes. More specifically, in the exemplary embodiment, second membrane system 122 includes any suitable “brackish water” membrane that is based on polyamide chemistry, such as, but not limited to, an AK brackish water membrane. In an alternative embodiment, second membrane system 122 includes an RO process membrane that is based on polyamide, polysuflonamide, cellulose acetate, and/or any other suitable chemistry that enables wastewater processing system 100 to function as described herein. In one embodiment, second membrane system 122 includes more than one RO process membrane, wherein the RO process membranes are in series to facilitate processing wastewater 172 that has a fluctuating amount of total dissolved solids as the wastewater 172 flows through processing system 100. In such an embodiment, second membrane system 122 may includes a first stage RO process membrane and a second stage RO process membrane with a booster pump in between the stages. Alternatively, the second membrane system 122 may include electrodialysis reversal (EDR) process that utilizes electrical energy to migrate ions into region of high solute concentrated wastewater 174.

During operation of separation system 104, in the exemplary embodiment, separation system 104 performs a separation process on the pretreated wastewater 172. More specifically, separation system 104 separates purified water 124 and concentrated wastewater 174 from the pretreated wastewater 172 and reduces the flow volume of wastewater through wastewater processing system 100. In one embodiment, the membrane within second membrane system 122 operates at approximately 60% to approximately 80% recovery such that approximately 60% to approximately 80% of the influent volume is recovered as permeate, while approximately 20 to approximately 40% of the influent volume is rejected as concentrate. For example, if an initial flow volume of pretreated wastewater 172 is approximately 1000 gallons per minute (gpm), then at 70% recovery, approximately 700 gpm of purified water 124 is returned to syngas generation system 10 as reclaimed permeate water and approximately 300 gpm of concentrated wastewater 174 is discharged from separation system 104 as reject or concentrate to be processed via subsequent unit operations, such as an evaporation operation. As such, less wastewater flows into subsequent systems within wastewater processing system 100, as compared to known water processing systems. The purified water 124 may be channeled to syngas generation system 10 for re-use within system 10. Alternatively, the purified water 124 may be stored in a nitrogen blanketed treated waster storage tank or a non-blanketed treated water storage tank.

In one embodiment, scaling of a membrane within second membrane system 122 may be caused by commonly-occurring, sparingly-soluble salts typically found in grey water, such as calcium phosphate, silica, silicates, calcium carbonate, and/or any other salts that may cause scaling and/or fouling. In the exemplary embodiment, to facilitate preventing fouling, such as scaling, of second membrane system 122 during concentration of pretreated wastewater 172, chemicals 126, are applied to pretreated wastewater 172 before it enters second membrane system 122. More specifically, chemicals 126, such as antiscalant chemicals (also referred to herein as “antiscalants”) and/or pH adjustments, are applied to separation system 104 from chemical store 84. The antiscalants may include, but are not limited to including, phosphonates and/or specialty polymers of a type to be effective for inhibiting fouling on RO membranes. More specifically, in the exemplary embodiment, the chemistry of an antiscalant is effective for preventing fouling while being compatible with the chemistry of the membrane within second membrane system 122 such that the antiscalant does not create a fouling condition that may be detrimental to the operation of the membrane within second membrane system 122. For example, the antiscalants are selected to prevent fouling of the membrane within second membrane system 122 without creating a fouling condition through reactions with the membrane chemistry. Further, in the exemplary embodiment, fouling of the membrane within second membrane system 122 is also facilitated to be minimized and/or prevented by pH adjustments to pretreated wastewater 172 prior to wastewater 172 entering second membrane system 122. Alternatively, antiscalants and/or pH adjustments are not applied before the RO process. In yet another alternative embodiment, an ancillary process of chemical disinfection and/or ultraviolet oxidation may be used to facilitate preventing and/or minimizing biofouling of the membrane within second membrane system 122.

The concentrated wastewater 174 is channeled from separation system 104 to ammonia stripping system 106 in the exemplary embodiment. From chemical store 84, chemicals 128, such as caustic chemicals, are supplied to ammonia stripping system 106. Further, steam 130, such as steam from plant steam system 86, is supplied to ammonia stripping system 106 to facilitate enhancing the reaction between the chemicals 128 and the concentrated wastewater 174, and to facilitate the removal and/or stripping of ammonia from the concentrated wastewater 174. For example, ammonia stripping system 106 discharges ammonia vapor 132 to a disposal unit and discharges stripper bottoms 176 into evaporation system 108. As used herein the term “stripper bottoms” refers to water that includes a reduced amount of ammonia and/or a reduced amount of other components that were removed by upstream processes, as compared to the wastewater 170 entering processing system 100. The stripper bottoms may include soluble chemical species, such as chloride and formate, that were in the original wastewater 170. Further, although the stripping of ammonia is described herein, ammonia may be removed from wastewater 172 using any suitable ammonia removal method, such as, for example, extraction.

Within evaporation system 108, the water within the stripper bottoms 176 is evaporated using steam 134 and/or chemicals 136. In the exemplary embodiment, evaporation system 108 is a thermal evaporation system, such as a falling film evaporator, that evaporates the liquid within the stripper bottoms 176 using heated surfaces. The evaporated stripper bottoms 176 are referred to herein as evaporator brine 178. In one embodiment, evaporation system 108 has a mechanical vapor compressor. In the exemplary embodiment, chemicals 136, such as caustic chemicals, antifoam chemicals, and/or acidic chemicals, are supplied to evaporation system 108 from chemical store 84, and steam 134 is supplied to evaporation system 108 from, for example, plant steam system 86. More specifically, in the exemplary embodiment, caustic chemicals may be used to adjust the pH of the evaporator brine 178, and antifoam chemicals may be supplied as needed. The interactions among the stripper bottoms 176, steam 134, and chemicals 136 produce distillate 138 that may be re-used within syngas generation system 10 and produce evaporator brine 178 that is further processed within wastewater processing system 100. As used herein, the term “distillate” refers to water that is substantially free of contaminates and/or impurities. The evaporator brine 178 is then channeled from evaporation system 108 to drying system 110. In an alternative embodiment, the distillate 138 may be stored in a nitrogen blanketed treated waster storage tank or a non-blanketed treated water storage tank.

In the exemplary embodiment, drying system 110 dries and/or crystallizes the evaporator brine 178 into, for example, steam vapor 140 and a salt crystal mixture 142. In the exemplary embodiment, steam 146 is supplied to drying system 110 from, for example, plant steam system 86, to dry evaporator brine 178. Drying system 110 may include a crystallizer, a centrifuge, a drum dryer, a spray dryer, and/or any drying and/or crystallizing system than enables wastewater processing system 100 to function as described herein. More specifically, in the exemplary embodiment, drying system 110 includes a dryer 148 and a crystallizer 150. Crystallizer 150 is included in drying system 110 to separate salt crystal mixture 142, such as chloride and formate salts, from liquid using, for example, a centrifuge. A portion of the separated liquid is returned to crystallizer 150 and another portion of the separated liquid is purged from drying system 110 as purge brine 152. In the exemplary embodiment, the purge brine 152 is re-used within gasifier 26 (shown in FIG. 1). The dryer 148 dries the evaporator brine 178 directly to salt mixture 142 and, as such, does not discharge a purge stream. Drying system 110 may produce a purge 152 that may be channeled to gasifier 26, and solids, such as salt mixture 142, which are channeled to a disposal unit.

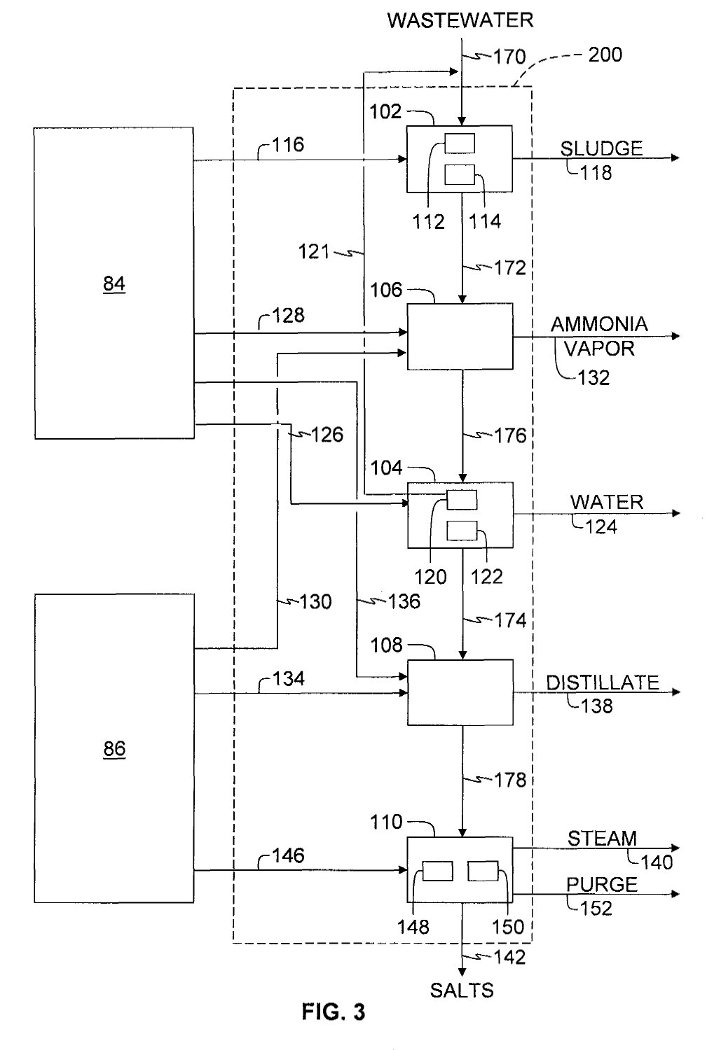

FIG. 3 is a schematic illustration of an alternative wastewater processing system 200 that may be used with syngas generation system 10 (shown in FIG. 1). Wastewater processing system 200 is substantially similar to wastewater processing system 100 (shown in FIG. 2), as described above, with the exception that ammonia stripping system 106 is upstream from separation system 104, rather than downstream from separation system 104, as described above. As such, like components are referred to with the same reference number. More specifically, in the exemplary embodiment, ammonia is removed and/or stripped from pretreated wastewater 172 in ammonia stripping system 106 before wastewater is concentrated within separation system 104. The stripper bottoms 176 produced by ammonia stripping system 106 are discharged into separation system 104, and concentrated wastewater 174 is discharged from separation system 104 into evaporation system 108.

The above-described systems and methods facilitate providing a ZLD process for wastewater. Specifically, the above-described separation system facilitates reducing the flow volume of wastewater to be stripped, evaporated, and/or dried. By reducing the flow volume of wastewater to such stripping, evaporation, and/or drying systems, the above-described separation system facilitates reducing the amount of steam that is channeled to stripping, evaporation, and/or drying systems, as compared to full-flow ZLD systems. As such, in the above-described wastewater processing system, rather than channeling steam to the stripping, evaporation, and/or drying systems, the steam can be channeled to a steam turbine to generate power. Further, because the above-described separation system reduces the flow volume of wastewater, the size of the evaporation and/or drying systems may be reduced as compared to evaporation and/or drying systems that process a full flow of wastewater.

Moreover, the above-described separation system facilitates providing water to other systems in flow communication with the wastewater processing system. For example, the wastewater processing system processes grey water produced by a gasification system and returns processed water to the gasification system as, for example, gasification make-up water. Because the above-described wastewater processing system reduces the flow volume of water within the wastewater processing system through concentration and supplies processed water back to the systems that produce wastewater, the above-described systems and methods facilitate reducing capital and/or operation costs associated with a wastewater producing system, such as a gasification system.

Exemplary embodiments of methods and systems for processing wastewater are described above in detail. The methods and systems are not limited to the specific embodiments described herein, but rather, components of systems and/or steps of the methods may be utilized independently and separately from other components and/or steps described herein. For example, the methods and/or systems may also be used in combination with other wastewater processing systems and/or methods, and are not limited to practice with only the gasification system as described herein. Rather, the exemplary embodiments can be implemented and utilized in connection with many other water processing applications.

Although specific features of various embodiments of the invention may be shown in some drawings and not in others, this is for convenience only. In accordance with the principles of the invention, any feature of a drawing may be referenced and/or claimed in combination with any feature of any other drawing.

While the methods and systems described herein have been described in terms of various specific embodiments, those skilled in the art will recognize that the methods and systems described herein can be practiced with modification within the spirit and scope of the claims.

What is claimed is:

1. A method for processing wastewater, said method comprising:
concentrating a flow of the wastewater using a reverse osmosis process membrane; and
evaporating the concentrated flow to produce at least distillate and solids.

2. A method in accordance with claim 1 further comprising pretreating the wastewater prior to concentrating the flow of the wastewater.

3. A method in accordance with claim 2, wherein pretreating the wastewater further comprises at least one of softening and coagulating the wastewater to facilitate removing from the wastewater at least one of a hardening substance, a scale-forming substance, a silica, a metal oxide, and an inorganic substance.

4. A method in accordance with claim 2, wherein pretreating the wastewater further comprises filtering the flow of the wastewater.

5. A method in accordance with claim 1 further comprising stripping at least ammonia from the flow of the wastewater.

6. A method in accordance with claim 1 further comprising drying the concentrated flow to produce at least distillate and solids.

7. A method in accordance with claim 1 further comprising stripping at least ammonia from the flow of the wastewater subsequent to concentrating the flow of the wastewater.

8. A method in accordance with claim 1 further comprising stripping at least ammonia from the pretreated flow prior to concentrating the flow of the wastewater.

9. A method in accordance with claim 1, wherein concentrating a flow of the wastewater using at least a reverse osmosis process membrane further comprises concentrating a flow of the wastewater using a filtration membrane and the reverse osmosis process membrane.

10. A method in accordance with claim 1, wherein concentrating a flow of the wastewater using at least a reverse osmosis process membrane further comprises concentrating a flow of grey water produced by a gasification process.

11. A method in accordance with claim 1 further comprising:
producing re-usable water from the wastewater; and
channeling the re-usable water to a system that produced the wastewater.

12. A system for processing wastewater, said system comprising:
a separation system comprising a reverse osmosis membrane, said separation system configured to reduce a flow volume of the wastewater; and
an evaporation system for receiving the reduced flow of the wastewater from said separation system.

13. A system in accordance with claim 12 further comprising a pretreatment system configured to treat the wastewater prior to the wastewater entering said concentration system.

14. A system in accordance with claim 13, wherein said pretreatment system comprises at least one of a filter system and a softening system.

15. A system in accordance with claim 12 further comprising an ammonia stripping system configured to strip at least ammonia from the wastewater.

16. A system in accordance with claim 12 further comprising a drying system configured to at least dry a concentrated flow of the wastewater to produce at least distillate and solids.

17. A system in accordance with claim 12, wherein said separation system comprises a filtration membrane and a reverse osmosis process membrane.

18. A separation system for processing wastewater, said separation system comprising:
a first membrane comprising a polymer film based filtration means; and
a second membrane comprising a reverse osmosis membrane material, said second membrane facilitates reducing a flow volume of the wastewater.

19. A system in accordance with claim 18 wherein said filtration polymer comprises at least one of a ultrafiltration membrane, a nanofiltration membrane, and a microfiltration membrane.

20. A system in accordance with claim 18 further comprising an antiscalant chemical configured to reduce fouling of at least said second membrane.
